(19) United States
(12) Patent Application Publication
(10) Pub. No.: US 2023/0242354 A1
(43) Pub. Date: Aug. 3, 2023

(54) Hydrojet Launcher and Booster for Hydraulic Capsule Pipelines

(71) Applicant: Baha Abulnaga, Bellingham, WA (US)

(72) Inventor: Baha Abulnaga, Bellingham, WA (US)

(73) Assignee: Mazdak International Inc., Sumas, WA (US)

(21) Appl. No.: 17/649,556

(22) Filed: Feb. 1, 2022

(51) Int. Cl. B65G 51/01

(52) U.S. Cl. CPC B65G 51/01; B65G 53/30

(57) ABSTRACT

The invention is for the purpose of launching and feeding capsules in a hydraulic pipeline based on the principle of a hydraulic jet. The jet nozzle in the body of the launcher creates a low pressure zone in the launcher in which capsules can be fed from a chute or a hopper at atmospheric pressure through a vertical indexing rotor without backflow of water into the hopper, chute or conveyor. The vertical indexing rotor is operated by a Geneva wheel system connected to a geared motor, or a servomotor controlled by a computer. The water pressure for the pipeline is provided by an external pump. The capsules are supplied by a dry conveyor, a hopper and a chute at the top of the launcher.

### FIELD OF THE INVENTION

The field of the invention is methods, systems, and devices for transporting sediments or goods in capsules in hydraulic capsules pipelines

### BACKGROUND TO THE INVENTION

The transportation of goods in capsules in hydraulic pipelines offers an opportunity to move sediments during dredging or mineral concentrate or tailings in pipelines in mining, using much lower water amounts than conventional slurry pipelines. Hydraulic capsule pipelines were studied extensively in the 1960's to 1990's particularly to transport coal as coal logs but the industry did not develop a simple pumping system. Most schemes to feed the capsules into the pipeline involve numerous locks and valves to feed trains of capsules. Liu (2005) describes two main systems

The multi-lock system the universal solution for hydraulic capsule pipelines involving conveyors, locks around the pump, auxiliary pumps to remove water between trains. Two sets of conveyors feed the pumping system. The partially submerge conveyors bring capsules from a storage facility and enter a water reservoir and enter a Y fitting through valves. Two conveyors feed the Y fitting, but only one branch is filled at a time through the timely opening of locks or valves. Water is not compressible so excess water must be removed using a small recirculating pump at the end of the Y fitting and at the entry of the hydraulic pipeline. By using a minimum of two conveyors the velocity of the conveyors is slowed down. If the capsule velocity in the pipeline is at 3 m/s, each of the two conveyors will move at 1.5 m/s. If four conveyors are used, then each can bring the capsules at the speed of 0.75 m/s.

A different concept called the pump bypass was developed in the 1960's at the Alberta Research Center in Canada, and further developed at the Capsule Pipeline Research Center, University of Missouri-Columbia, for use in association with coal log pipeline (CLP). This system is suitable as a booster in the hydraulic pipeline when the train of capsule is already in the pipeline. A Y pipe connection featuring a lock on each branch divert the trains of capsules to alternative branch. The system uses 8 valves to convert the energy from a centrifugal pump.

These cumbersome schemes are difficult to install and to transport from site to site, particularly when rapid mobility is needed such as in dredging schemes.

One principle of feeding solids from a hopper into pneumatic transport system is called the solids handling eductor. This approach has not been applied in the past for feeding capsules into a water pipeline under pressure. I have therefore developed a new invention to feed capsules from atmospheric pressure to pipeline pressure based on the principle of the jet dynamics.

Our approach is based on modifying a jet pump by combining with a rotary capsule feeder.

### REFERENCES

Abulnaga B. E. 2021 “Slurry Systems Handbook” McGraw-Hill—2^{nd} Edition Liu H.2005. Liu H. 2005—Pipeline Engineering—Lewis Publishers (now CRC Press) Boca Ranton, Fla., USA
U.S. Pat. No. 4,946,317 Coal Log Pipeline System and Methods of Operation. Inventors Henry Liu, Thomas R. Marrow—Granted Aug. 7, 1990
Abulnaga B. E. application Ser. No. 17/135,904—Pump Engine for hydraulic capsule pipeline

### SUMMARY OF THE INVENTION

A capsule pipeline system that operates of the principle of feeding capsules through a timed rotor into a pipeline cavity chamber in which a very high velocity jet is applied from a nozzle against the capsule. As the jet expands it entrains air from the rotary feeder around the capsules and prevents water from flowing back into the chute or feeding hopper. The rapid entrainment of the capsule and air is followed by a compression of the air and water jet allowing recovery of pressure and providing energy for the transport of the capsule in the pipeline. With a suitable attachment, a version of the launcher is adapted as a pressure booster in the pipeline.

### BRIEF DESCRIPTION OF THE DRAWINGS

FIG. 1 presents a block diagram for the principle of operation of the invention

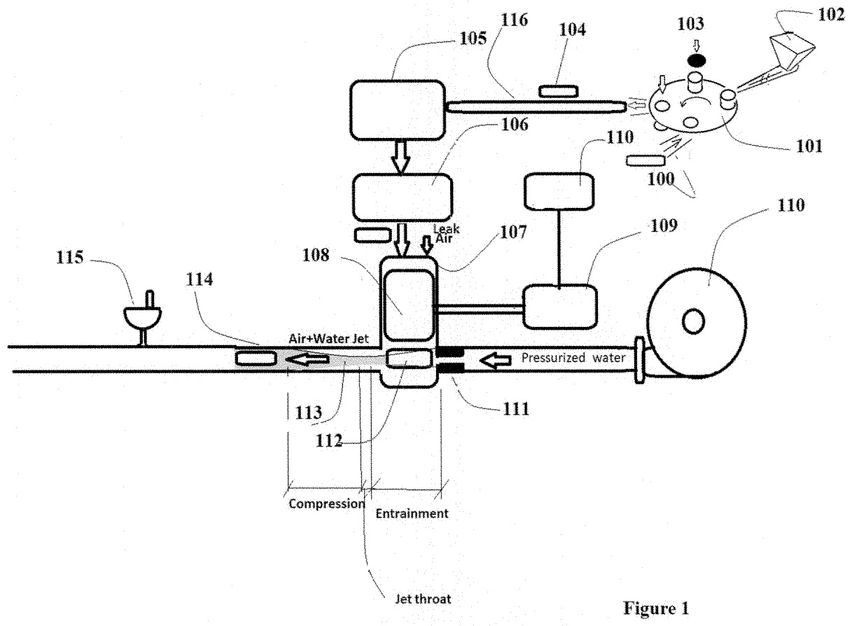

FIG. 2 presents the capsule launcher including casing, rotor, cover with the casing incorporating the jet nozzle and the chamber to entrain the capsule through the jet.

FIG. 3.—presents an artistic representation of the capsule launcher being fed from a dry conveyor at the top, and water pressure at the bottom and capsules entering the water pipeline

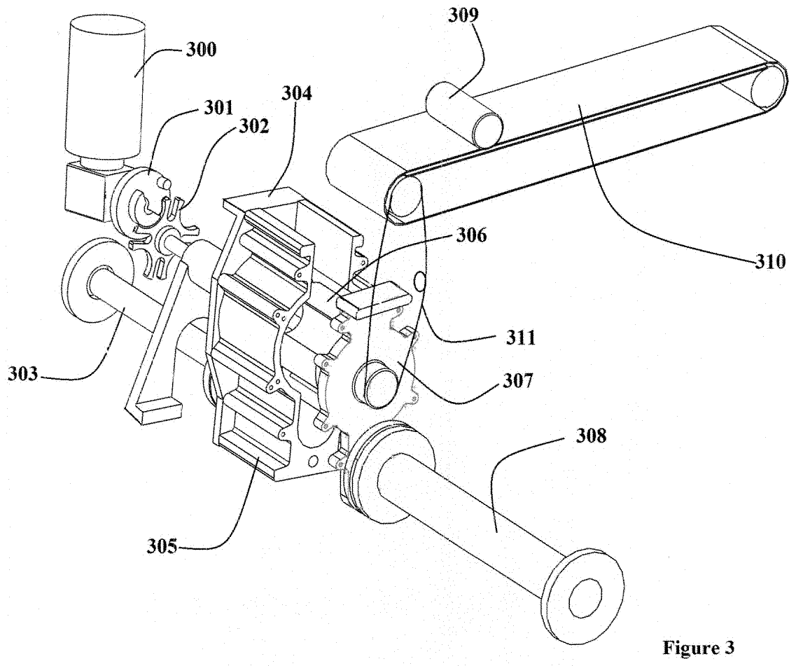

FIG. 4 presents an installation as a booster in the hydraulic capsule pipeline with an attachment to capture the capsule, re-direct the capsule into the launcher and boost the water pressure by an external pump.

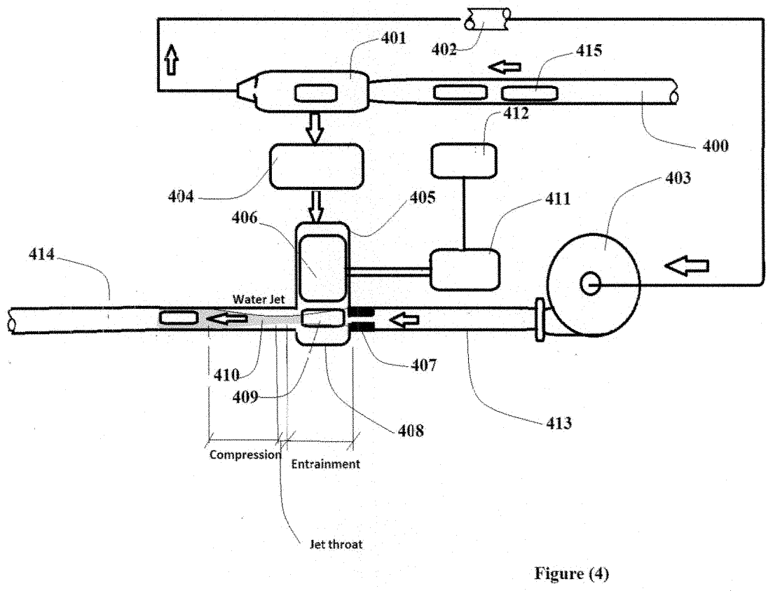

FIG. 5 presents an artistic representation of the capsule launcher in a booster configuration to boost the pressure from an incoming hydraulic capsule pipeline to a higher pressure.

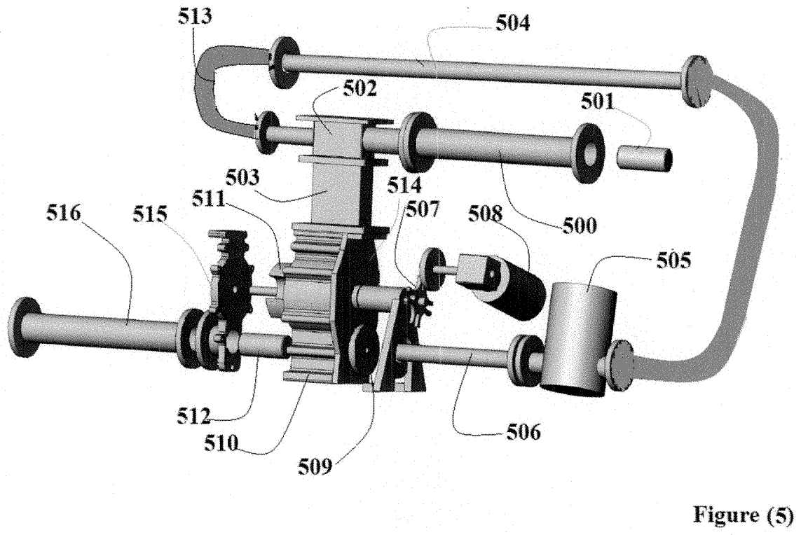

### DETAILED DESCRIPTION OF THE INVENTION

FIG. (1) presents a block diagram for the proposed invention. An empty capsule (100) is fed to a capsule filling machine consisting of an indexing table (101) with a minimum of four positions for (a) accepting an empty capsule, them rotating by 90 degrees into a position where it can be filled from a hopper (102), a third position at 180 degrees for capping (103) and a final position at 270 degrees so that the filled capsule (104) is dropped into a dry conveyor (105), The conveyor discharge into a hopper and chute (106), connected to the capsule feeder (107). The feeder includes a vertical slotted and indexing rotor (108) driven by a Geneva gear (109) and a geared motor (110). In some versions of the invention this geared motor and Geneva gear are replaced by a servomotor with a computer numerical control system. The indexing rotor transports the capsule from the top of the feeder to a chamber (112) on which is installed a jet nozzle (111) to feed pressurized water from a water pump (110), The jet creates a low pressure zone in the chamber (112) and entrains some air from the chute (106) as the capsule enters the launcher. The air and water form a jet (113) that surrounds and entrain the capsule into the pipeline (114). An air release valve (115) is installed further downstream at a high point in the pipeline to remove entrained air.

FIG. (2) shows an embodiment of the capsule launcher. The casing (200) features a channel (201) for the capsule to enter the rotor (202). The rotor features one or more slots (203). The rotor is fixed to a shaft (204) and supported by a bearing assembly (205). At the bottom of the casing, below the rotor, a chamber (206) features a jet nozzle (207) and is designed to receive a capsule through a half-turn of the rotor. The back cover (209) of the launcher features a blind flange (208) drilled for the nozzle (206). The said flange (208) is threaded or drilled with a bolt pattern to connect a pipe from an external water pump or source of water pressure. The front cover plate (210) of the launcher incorporates a nozzle (211) for exit of the launched capsule with a suitable flange (212) to connect to the hydraulic capsule pipeline.

FIG. (3) shows a version of the invention a motor (300) driving the capsule launcher through a cam (301) and Geneva gear (302). The capsule launcher consists of a backcover (304) including a nozzle directly connected to a pipe (303) connected to an external source of water pressure, the capsule launcher body of the capsule launcher (305) the rotor (306) and the front cover (307), Capsule (309) enters the capsule launcher, through a conveyor (310) The conveyor is synchronized with the rotation of the capsule rotor through by belt and pulleys (311). The capsule leaves through pipeline (308).

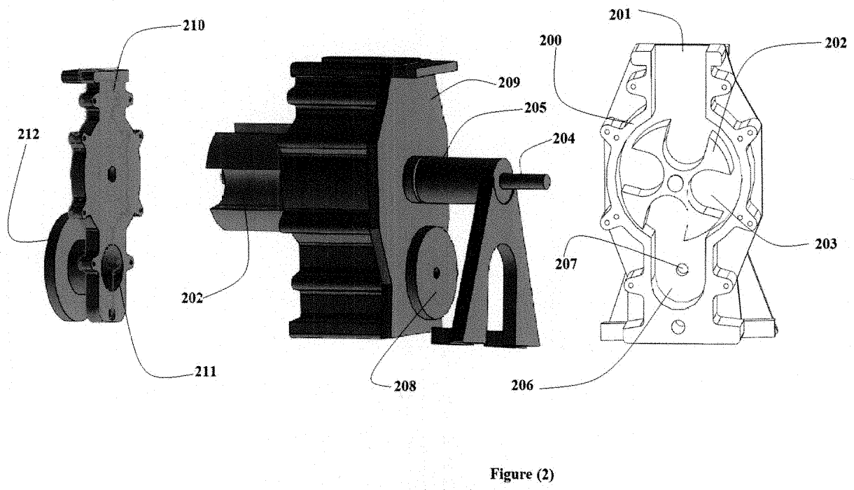

The concept of the invention is illustrated in FIG. (6). Capsules filled of sediments from dredging operations, or tailings or concentrate from mining operations are delivered dry to the capsule launcher by standard conveyors through a vertical chute or hopper and chute combination. The launcher operates on an intermittent way and is driven from a geared electric motor or an engine with a gear box, The launcher (FIG. 2) features a slotted rotor (202) with a minimum of two slots and preferably four slots (203) for capsules to slide in from the chute at the top into a chamber (201) at the bottom of the launcher (206).

Water enters the chamber through a small high pressure nozzle (FIG. 6— item (111)) that creates a jet. The pressure of water from a water pump upstream the jet is converted into very high kinetic energy. This creates a local low pressure or partial vacuum in which some air leaks from the chute into the chamber but it also prevents water from backing up through the launcher to the chute and conveyor. It becomes therefore possible to feed continuously capsules from an atmospheric pressure into a water pipeline without complex locks and bypass pumps.

Water enters the capsule launcher through the nozzle (111) from upstream conditions with pressure P₁ and velocity V₁ and density ρ₁

The jet hits the capsule falling in the chamber at the bottom of the capsule launcher in a very turbulent way. The capsule lifts off immediately as it enters the chamber, by exchanging momentum with the expanding jet. There is an entrainment phase, followed by a sort of compression of any air entrained in the process.

At high points downstream of the launcher, air release valves (115) are installed, but we shall focus first on the forces in the entrainment, throat and compression phases.

At the nozzle the velocity increases to V_{N} causing a reduction of pressure in the lower half of the capsule launcher and entraining air as the capsule drops. This results into a fluid density ρ₂

Applying Bernoulli's equation across the nozzle

$${P}_{1} + \frac{1}{2} {ρ}_{1} {V}_{1}^{2} = {P}_{N} + \frac{1}{2} {ρ}_{N} {V}_{N}^{2} \qquad ( Eqn 1 )$$

At the tip of the nozzle before the mixing with air develops we may consider

$${ρ}_{1} = {ρ}_{N} = 1000 kg / {m}^{3} {V}_{N}^{2} ∼ \frac{2 ( {P}_{1} - {P}_{N} )}{{ρ}_{1}} \qquad ( Eqn 2 )$$

For the air to flow into the launcher cavity the pressure P_{N} must be atmospheric or sub-atmospheric. The maximum value of P_{N} is therefore 100 kPa (absolute) or 0 kPa (gauge). For example an absolute pressure of 200 kPa expanding into atmospheric pressure would result in an ideal jet velocity of 14 m/s. The ideal velocity is however corrected due to the Vena Contrata effect depending on the shape of the nozzle by a discharge coefficient

Although the ideal velocity at the tip is high (between 11.8 and 18.6 m/s) in the range of pressures from 69 to 172.3 kPa (gage) or (10 to 25 psi (gage)), the velocity quickly drops with entrainment of air and expansion of the flow around the capsule.

The density of the fluid downstream of the tip is due to a mixture of air and water. A degree of compression of the air is to be expected as the water recovers pressure, At point 2 (FIG. 2).

In the entrainment and compression zone, the velocity reduces to a value corresponding to the flow surrounding the capsule. This value is however different than the capsule velocity due to some slip.

The capsule is subject to buoyancy, lift and drag forces, and possibly pitching moment based on the density of the air+water mixture

For a cylindrical capsule of outer diameter d_{c} and length l_{c} the volume of the capsule is

$$π {r}^{2} \frac{π}{4} {d}_{c}^{2} {l}_{c} \qquad ( Eqn 3 )$$

Due to the process of entrainment of air, the buoyancy force will change along the entrainment and compression zone and is expressed as

$$V o {l}_{c} = \frac{π}{4} {d}_{c}^{2} {L}_{c}$$

The buoyancy force due to the volume of displaced fluid is therefore

$${B}_{c} ( x ) = {ρ}_{m} ( x ) g \frac{π}{4} {d}_{c}^{2} {l}_{c} . \qquad ( Eqn 4 )$$

At the end of the compression zone,

$${B}_{c} ( x ) = p ( x ) π {r}^{2} g \frac{π}{4} {d}_{c}^{2} {l}_{c} \qquad ( Eqn 5 )$$

At the end of the compression zone

$${B}_{c 2} = {ρ}_{2} π {r}^{2} g \frac{π}{4} {d}_{c}^{2} {l}_{c} \qquad ( Eqn 6 )$$

Strictly speaking the density changes with distance ρₘ(x) through the entrainment and compression length with final value ρ₂ at the end of the compression phase.

In the entrainment zone the velocity is sufficiently high to develop a hydrodynamic lift force C_{L}(x), The lift coefficient depends on the shape of the capsule, the Reynolds Number and angle of attack. The changes in Reynolds Number occur as the velocity decreases through the transient mode, while density ad viscosity change.

$${L}_{c} ( x ) = {ρ}_{m} ( x ) \frac{π}{8} {d}_{c} {{l}_{c} ( {V}_{m} - {V}_{c} )}^{2} {C}_{L} ( x ) \qquad ( Eqn 7 )$$

At the end of the compression phase, the lift coefficient reaches the magnitude of C_{L2} at the mixture density ρ₂. The lift force reduces to

$${L}_{c 2} = {ρ}_{2} \frac{π}{8} {d}_{c} {{l}_{c} ( {V}_{2} - {V}_{c} )}^{2} {C}_{L 2} \qquad ( Eqn 8 )$$

During the entrainment and compression phase, a drag force develops. The drag force change during the entrainment and compression phase

$${D}_{c} ( x ) = {ρ}_{m} ( x ) \frac{π}{8} {d}_{c} {{l}_{c} ( {V}_{m} - {V}_{c} )}^{2} {C}_{D} ( x ) \qquad ( Eqn 9 )$$

The drag coefficient Co is based on the external surface of the capsule, not just its frontal area.

At the end of the compression phase, the drag coefficient reaches C_{D2} at the mixture density ρ₂. The drag force stabilizes to

$${D}_{c 2} = {ρ}_{2} \frac{π}{8} {d}_{c} {{l}_{c} ( {V}_{2} - {V}_{c} )}^{2} {C}_{D 2} \qquad ( Eqn 10 )$$

The net normal force on the capsule must be calculated to determine the sliding friction on the capsule.

N_{c}(x)=(L_{c}(x)|B_{c}(x))−W_{c} (Eqn 11)

At the end of the compression phase, the normal force is

N_{c2}=(L_{c2}+B_{c2})−W_{c} cos(α) (Eqn 12)

Where α is the angle of inclination of the pipe

If the velocity V₂ is sufficient high, the capsule maintains an annular flow and does not come in contact with the wall of the pipe. However if the flow slows down due to blockage or excessive increase of the cross sectional area, the capsule starts to rub against the pipe wall and develops a sliding friction force

Fₛ=μₛN_{c} (Eqn 13)

We did however observe that the capsule is entrained fast enough to be fully suspended so that it does not go through the normal incipient motion described in classical capsule theory.

The Bernoulli equation is applied across the jet
from the nozzle to the final position at end of entrainment into the throat of the jet
from the throat of the jet to the et id of compression

A level of pressure recovery occurs at the end of the compression phase. Until air is removed further in the pipeline at a high point the fluid surrounding the capsule will remain a mixture of water and entrained air, or water with slugs of air depending on the pressure profile and temperature along the pipeline through dedicated air release valves. The pressure of the pipeline is increased downstream by using the capsule launcher in a booster mode.

FIG. (4) presents an arrangement for the capsule launcher as a booster from an incoming hydraulic pipeline (400). A special attachment (401) acts as a stop to redirect the capsule from a horizontal direction to a drop through a pressurized chute (404). Water from the attachment (401) is redirected to the booster pump (403) through a suction pipe (402). The booster pump delivers pressurized water (413) into the nozzle in the rear cover plate (407) of the launcher (405), The chute (404) directs the incoming capsule into the launcher (405). The indexing rotor (406) transfers the capsule (409) from the top of the launcher into the jet chamber (408), where it encounters the jet from the nozzle (407) and is entrained into the jet (410) into the discharge pipeline (414).

FIG. (5) presents an artistic representation of the launcher in a booster configuration. Capsule (501) is delivered through the hydraulic capsule pipeline (500) to the capsule stopper (502) while water is extracted through hose (513) and/or pipe (504) to a booster pump (505). The incoming capsule enters chute (503) to the capsule launcher (510), The capsule launcher rotor (511) transfers the capsule to the jet chamber of the launcher where a jet is formed by pumping water through pipe (506) and jet nozzle (509) in the rear cover plate (514). The capsule (512) is projected through the flange of the front coverplate (515) into the high pressure pipeline (516).

What is claimed is:

1: A method of feeding capsules filled with sediments, mineral concentrates, tailings or products into a hydraulic capsule pipeline from a hopper and chute at atmospheric pressure into a pressurized water pipeline, through a capsule launcher featuring a dedicated nozzle to produce a jet that entrains the capsule and a limited amount of leak air into the low pressure zone created by the high speed jet from the said nozzle, where the speed of the jet is the result of the high pressure from a water pump upstream the nozzle, and the resultant jet lifts off the capsule in the chamber at the bottom of the launcher, to entrain it into the pipeline through a region of entrainment followed by compression of the air and water mixture through a recovery of pressure as the velocity of the jet drops to the pipeline average velocity.

2- A hydraulic capsule pipeline launcher consisting of a casing, a front cover, a rear cover, a vertical indexing rotor with one or multiple slots for transferring capsules from a chute and a hopper above the launcher into a chamber at the bottom of the launcher, where a very high speed jet is generated from a nozzle at the center of a blind flange of the rear cover facing the center of the casing chamber below the rotor so that the jet generated from the pressure at the nozzle is converted into a high speed jet to entrain the capsule through the front cover nozzle and flange to a hydraulic capsule pipeline, and where the slotted rotor transporting the capsules from the inlet at the top of the launcher to the jet chamber at the bottom is operated in an indexing mode by a shaft connected to a geared motor through a Geneva gear and cam mechanism, or connected to servomotor operated from a computer control center.

3. A capsule launcher designed for installation as a pressure booster in a hydraulic capsule pipeline, by incorporating a special attachment, to redirect the capsule into a pressurized chute connected to the launcher, and piping to redirect the low pressure water into an external booster pump that reinjects pressurized water into the nozzle of the launcher back cover plate to generate a high pressure water jet to entrain and propel capsules in the jet chamber after passing through the indexing rotor and boost the pressure in the hydraulic capsule pipeline downstream the launcher.
